(19) United States
(12) Patent Application Publication
(10) Pub. No.: US 2025/0383266 A1
(43) Pub. Date: Dec. 18, 2025

(54) TECHNIQUES FOR VALIDATING TEST PLANS GENERATED USING ARTIFICIAL INTELLIGENCE

(71) Applicant: Honeywell International Inc., Charlotte, NC (US)

(72) Inventors: Abhishek Alladi, Hyderabad (IN); Aralakuppe Ramegowda Yogesha, Bangalore (IN); Pradeep Sadananda, Bangalore (IN); Srikanth Nagaraj, Bangalore (IN); Jayakumar S S, Bangalore (IN); Debabrata Pal, Kolkata (IN)

(73) Assignee: Honeywell International Inc., Charlotte, NC (US)

(21) Appl. No.: 18/829,962

(22) Filed: Sep. 10, 2024

(30) Foreign Application Priority Data
Jun. 13, 2024 (IN) 202411045773

(51) Int. Cl. G01M 99/00; G06F 18/22

(52) U.S. Cl. CPC G01M 99/005; G06F 18/22

(57) ABSTRACT

Techniques are generating a test plan, based on test requirements, using artificial intelligence (AI) whilst avoiding hallucinations. Hallucinations in the AI generated test plan may be reduced by utilizing generative AI and providing the generative AI with pre-defined custom templates, test plan guidelines, and/or information for selecting a test environment based on test type. Additionally or alternatively, a similarity between the test plan and a similar test plan may be determined to avoid hallucinations.

### CROSS-REFERENCE TO RELATED APPLICATION

This application claims priority to Indian Provisional Patent Application No. 202411045773 filed on Jun. 13, 2024, the contents of which are incorporated herein by reference in their entirety.

### BACKGROUND

Modern avionics systems require testing to ensure the safety of an aircraft. The development of test plans is complex and labor intensive. Generative artificial intelligence (AI) may be used to develop such test plans.

Generative AI (GAI), however, is susceptible to hallucinations. Hallucinations are incorrect or incomplete results. Thus, there is a risk that generative AI may generate test plans for avionics system which are incorrect and/or incomplete.

### SUMMARY

In some aspects, the techniques described herein relate to a method for automatically generating a new test plan, the method including: receiving requirements for the new test plan; determining a similarity between requirements for each of one or more pre-existing test plans and the requirements for the new test plan; determining whether any requirements of each of one or more pre-existing test plans have a similarity with the requirements for the new test plan which exceeds a first similarity threshold level; determining that requirements of one or more pre-exiting test plans have a similarity with the requirements for the new test plan exceeds the first similarity threshold level, then providing to artificial intelligence (AI), each similar test plan and corresponding similar requirements thereof, and the requirements for the new test plan, wherein a similar test plan is a pre-existing test plan whose requirements' similarity with the requirements for the new test plan exceeds the first similarity threshold level, and wherein similar requirements are requirements, of a pre-existing test plan, whose similarity with the requirements for the new test plan exceeds the first similarity threshold level; using each similar test plan and corresponding similar requirements thereof, and the requirements for the new test plan, generating, with the AI, a new test plan; determining a similarity between the new test plan and each similar test plan; using the determined similarity between the new test plan and each similar test plan, providing and/or modifying the similarity between each of the corresponding similar requirements and the requirements for the new test plan; determining whether at least one determined similarity between the new test plan and a similar test plan exceeds a second similarity threshold level; and determine that the at least one determined similarity exceeds the second similarity threshold level, then providing the new test plan to a user and/or a system.

In some aspects, the techniques described herein relate to an apparatus for automatically generating a new test plan, the apparatus including: state machine circuitry configured to: receive requirements for the new test plan; determine a similarity between requirements for each of one or more pre-existing test plans and the requirements for the new test plan; and determine whether any requirements of each of one or more pre-existing test plans have a similarity with the requirements for the new test plan which exceeds a first similarity threshold level; and neural network circuitry configured to execute artificial intelligence (AI), and further configured to: determining that requirements of one or more pre-exiting test plans have a similarity with the requirements for the new test plan exceeds the first similarity threshold level, then receiving at the AI, each similar test plan and corresponding similar requirements thereof, and the requirements for the new test plan, wherein a similar test plan is a pre-existing test plan whose requirements' similarity with the requirements for the new test plan exceeds the first similarity threshold level, and wherein similar requirements are requirements, of a pre-existing test plan, whose similarity with the requirements for the new test plan exceeds the first similarity threshold level; and using each similar test plan and corresponding similar requirements thereof, and the requirements for the new test plan, generating, with the AI, a new test plan; wherein the state machine circuitry is further configured to: determine a similarity between the new test plan and each similar test plan; using the determined similarity between the new test plan and each similar test plan, provide and/or modify the similarity between each of the corresponding similar requirements and the requirements for the new test plan; determine whether at least one determined similarity between the new test plan and a similar test plan exceeds a second similarity threshold level; and determine that the at least one determined similarity exceeds the second similarity threshold level, then provide the new test plan to a user and/or a system.

In some aspects, the techniques described herein relate to a method for automatically generating a new test plan, the method including: receiving requirements for the new test plan; using one of pre-defined custom templates, the requirements for the new test plan, generate, with artificial intelligence (AI), the new test plan whilst applying test plan guidelines for each test of the new test plan; wherein generating the new test plan includes selecting an environment for each test of the new test plan based on a type of test of each test; and providing the new test plan to a user and/or a system.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 illustrates a state machine communicatively coupled to a neural network;

FIG. 2A illustrates a flow diagram of one embodiment of a method of using generative AI to automatically develop a complete and correct test plan for a device;

FIG. 2B illustrates a flow diagram of one embodiment of a method of obtaining or determining a similarity between requirements for each of one or more pre-existing test plans and the requirements for the new test plan;

FIG. 3 illustrates a flow diagram of one embodiment of a method of generating, with generative AI, a new test plan;

FIG. 4 illustrates a flow diagram of one embodiment of a method of generating, with generative AI, a new test plan;

FIG. 5 illustrates a flow diagram of one embodiment of a method of obtaining user and/or system approval of a new test plan when at least one determined similarity between the new test plan and a similar test plan does not exceed a second similarity threshold level;

FIG. 6 illustrates a flow diagram of one embodiment of a method of generating a new test plan; and

FIG. 7 illustrates a flow diagram of one embodiment of a method of determining whether at least one determined similarity between the new test plan and a similar test plan exceeds the second similarity threshold level is determined.

In accordance with common practice, the various described features are not drawn to scale but are drawn to emphasize specific features relevant to the exemplary embodiments. Reference characters denote like elements throughout figures and text.

### DETAILED DESCRIPTION

In the following detailed description, reference is made to the accompanying drawings that form a part hereof, and in which is shown by way of illustration specific illustrative embodiments. However, it is to be understood that other embodiments may be utilized, and that structural, mechanical, and/or electrical changes may be made. Furthermore, each method presented in the drawing figures and the specification is not to be construed as limiting the order in which the individual steps may be performed. The following detailed description is not to be taken in a limiting sense.

For pedagogical purposes, artificial intelligence is described as generative artificial intelligence. Embodiments of the invention are applicable to artificial intelligence generally including types of artificial intelligence which may or may not be generative artificial intelligence.

Optionally, such artificial intelligence may be implemented by at least one encoder, at least one decoder, at least one sequency model, and/or at least one of any other component used in an artificial intelligence. Each encoder is configured to translate input data into vector data which can be more easily processed by the artificial intelligence. Each decoder is configured to translate vector data generated by the artificial intelligence into output data which can be more easily be understood by a human and/or another system. A sequency model is configured to capture patterns and/or make predictions.

Embodiments of the invention provide a technological improvement to automated creation, using generative artificial intelligence, of test plans, e.g., for vehicle components and vehicle systems. Embodiments of the invention identify hallucinations and prevent test plans, provided by generative AI, which are incomplete and/or erroneous from being provided to a user and/or a system.

Such components and systems may be, for example, for airborne vehicles (e.g., aircraft), land vehicles (e.g., automobiles), and any other type of vehicle. Embodiments of the invention utilize generative AI in combination with at least one similarity checker, e.g., operating on a state machine. Generative AI may be implemented using small language models, medium language models, large language model, transfer learning techniques, and/or transformer techniques.

Upon receiving requirements for a new test plan, optionally, one similarity checker seeks, using a state machine, to identify one or more similar pre-existing requirements (each of which has a corresponding pre-existing test plan). Using the pre-existing test plan(s) of any similar pre-existing requirements, the generative AI generates a new test plan. A similarity between the new test plan and each of the pre-existing test plan(s), of any similar pre-existing requirements, is determined using the state machine. Optionally, each similarity between the new test plan and each of the pre-existing test plan(s), a similarity between the similar pre-existing requirements and the requirement for the new test plan may be modified. If the new test plan and at least one of the pre-exiting test plan(s) are sufficiently similar, then the new test plan is provided to a user and/or a system. For pedagogical purposes, certain functions are illustrated as being performed by the state machine; in other embodiments, one or more of such functions may be implemented in the generative AI.

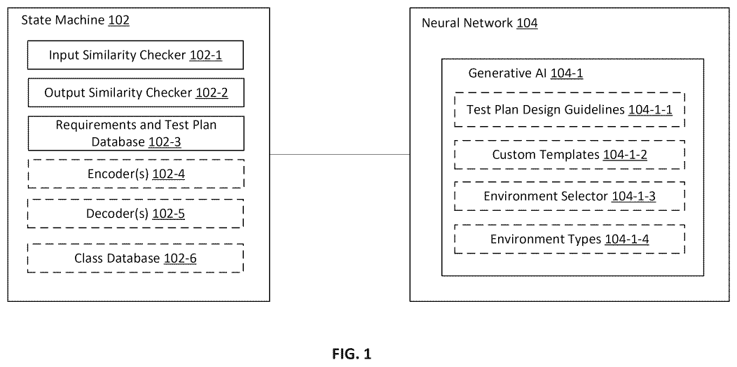

FIG. 1 illustrates a state machine (or state machine circuitry) 102 communicatively coupled to a neural network (or neural network circuitry) 104. The neural network 104 is configured to store and execute the generative AI 104-1. Optionally, the generative AI 104-1 includes one or more of: test plan guidelines 104-1-1, pre-defined custom templates (or custom templates) 104-1-2, an environment selector 104-1-3, and environment types 104-1-4. Optionally, the state machine 102 includes an input similarity checker 102-1, an output similarity checker 102-2, a requirements and test plan database 102-3, optionally at least one encoder 102-4, optionally at least one decoder 102-5, and an optional class database 102-6.

The requirements and test plan database 102-3 is configured to store pre-existing test(s) and requirements for each such pre-existing test. Such pre-existing test(s) and requirements for each such pre-existing test are stored in the requirements and test plan database 102-3 in a format which is in a human and/or a machine readable format. Each of the optional encoder(s) 102-4 is configured to convert data in a human and/or a machine readable format, e.g., the pre-existing test(s) and requirements for each such pre-existing test, into vectorized elements in vector space which is readily processed by component(s) of embodiments of the invention, e.g., the artificial intelligence or other portion(s) of embodiments of the invention. Each of the optional decoder(s) 102-5 is configured to convert data in vectorized elements in vector space generated by component(s) of embodiments of the invention, e.g., the artificial intelligence or other portion(s) of embodiments of the invention, into a human and/or a machine readable format.

A test plan includes one or more tests. The test plan guidelines 104-1-1 includes conditions for each test of a test plan, and selection of an environment. Such conditions may include expected data structures, and expected data for example parameter values and/or ranges (e.g., minimum, maximum, and nominal values) for input(s) and/or output(s) of each test. Such expected data structures are elements which would be necessary for a test which is provided to the generative AI on a test type by test type basis and/or are selected by the generative AI for a particular test generated by the AI based on the test type generated by the AI. The environment is an environment in which the test is performed, and may be a physical environment utilizing hardware (and optionally software) and/or a simulated environment. The pre-defined custom templates 104-1-2 specifies input(s), output(s), and an environment for different types of tests.

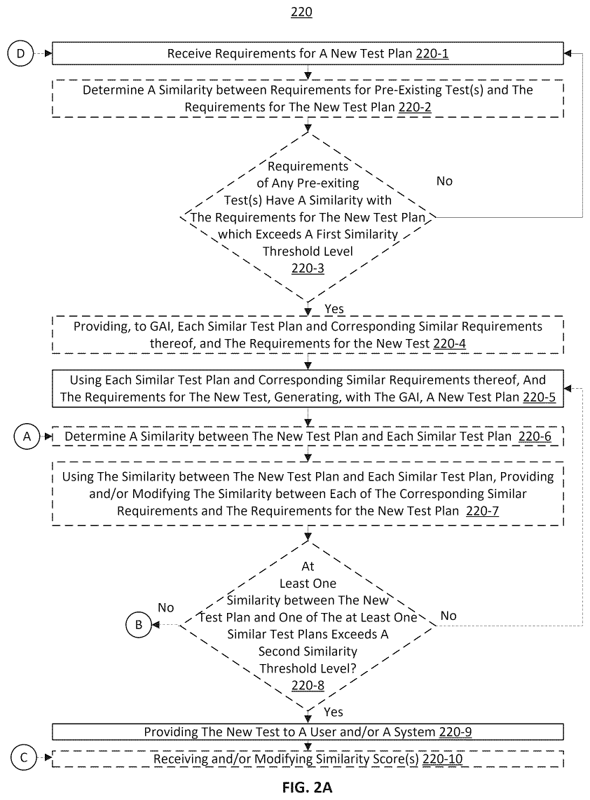

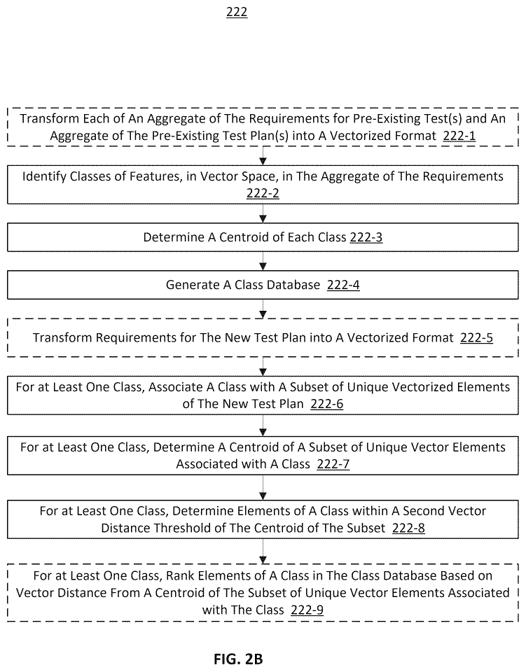

FIG. 2A illustrates a flow diagram of one embodiment of a method 220 of using generative AI to automatically develop a complete and correct test plan for a device. Exemplary methods described herein may be implemented by the apparatus illustrated in FIG. 1. To the extent the methods herein are described herein as being implemented with the apparatus illustrated in FIG. 1, it is to be understood that other embodiments can be implemented in other ways. Techniques described with respect to the embodiments illustrated by FIG. 1 may be applicable to the methods described herein. Optionally, each block of method 220 is performed by the state machine or the neural network, e.g., the generative AI.

The blocks of the flow diagrams herein have been arranged in a generally sequential manner for ease of explanation; however, it is to be understood that this arrangement is merely exemplary, and it should be recognized that the processing associated with the methods (and the blocks shown in the Figures) can occur in a different order (for example, where at least some of the processing associated with the blocks is performed in parallel and/or in an event-driven manner).

In block 220-1, requirements for a new test plan are received, e.g., by the state machine. Such requirements for the new test plan may be received from a user and/or a system. Optionally, block 220-1 includes user and/or system input providing and/or revising one or more elements of test plan guidelines for at least one test of the new test plan and/or providing and/or revising one or more pre-defined custom templates. Optionally, block 220-1 includes user and/or system input providing, e.g., a set of, test environments. Optionally, in block 220-1, the requirements for a new test plan are received in a human and/or machine readable format, or in vectorized elements in vector space for example from a class database. Optionally, in block 220-1, requirements for one or more pre-exiting test plans and one or more test plans (or alternatively an aggregate of the requirements for each of the one or more pre-existing test plans and an aggregate of such one or more test plans) are received, e.g., from the requirements and test plan database; optionally, each such data is received in a human and/or machine readable format, or in vectorized elements in vector space for example from the class database.

In optional block 220-2, a similarity between requirements for each of one or more pre-existing test plans and the requirements for the new test plan are obtained or determined. Requirements as used herein means document(s), diagram(s), picture(s), table(s), and/or any other way of representing information. Optionally, the one or more pre-existing test plans is stored in the requirements and test plan database of the state machine. Optionally, similarity may be determined by one or more ways including without limitation using techniques to determine a similarity of context of words in two documents, e.g., the cosine similarity technique, the Euclidian distance technique, and/or the Jaccard similarity technique.

FIG. 2B illustrates a flow diagram of one embodiment of a method 222 of obtaining or determining a similarity between requirements for each of one or more pre-existing test plans and the requirements for the new test plan. However, block 220-2 may be implemented in other ways. Optionally, each block of method 222 is performed by the state machine or the neural network, e.g., the generative AI.

In optional block 222-1, each of the aggregate of the requirements for the one or more pre-existing test plans and the aggregate of the one or more test plans are transformed into vectorized elements in vector space, e.g., by an encoder of the encoder(s). In block 222-2, classes of features, in vector space, in the aggregate of the requirements for the one or more pre-existing test plans are identified. Such identification is performed by identifying groupings of vector elements in a vector space. Such classes may, for example, pertain to functional testing, input(s) and/or output(s), and/or timing of signal(s); however, the classes may additionally or alternatively include other feature(s) of the one or more pre-existing test plans. In block 222-3, a centroid, e.g., a mean or a geometric mean, of each identified class is determined. The centroid is obtained by determining the centroid of the vector elements forming a corresponding grouping in the vector space.

In block 222-4, the class database 102-6 is generated. The class database includes, for each class, a vector value for each element, of each class, and the centroid for each class. The class database also includes for each vector value of an element of the class, a vector value for an element of the pre-existing test plan (which corresponds to the element of the class) and optionally the environment associated with the element of the pre-existing test plan. An element of the class is of a requirement. Optionally, the class database is stored in the requirements and test plan database and is used to provide data for requirements for pre-existing test(s) and/or such pre-existing test(s) in blocks of FIG. 2A.

In optional block 222-5, the requirements for the new test plan are transformed into vector space into vectorized elements in vector space, e.g., by an encoder of the encoder(s). In block 222-6, for at least one, e.g., for every, class, a subset of unique vector elements in vector space is associated with a class. This may be performed by identifying each vector element within a first vector threshold distance of a centroid of the class. Thus, each of one or more classes may be associated with a different subset of unique vector elements.

In block 222-7, for at least one, e.g., for every, class, a centroid, of the subset of unique vector elements associated with a class, is determined. In block 222-8, for at least one, e.g., for every, class, elements of a class (in the class database), within a second vector threshold distance of the centroid of the class, are determined. The identified requirement(s) and identified corresponding test plans are the respectively the similar test plan(s) and similar requirement(s).

In optional block 222-9, for at least one, e.g., for every, class, elements of a class in the class database are sorted (or ranked) based on a vector distance of the element from a centroid of the subset of Unique vector elements associated with the class. Optionally, the sorted (or ranked) class database is stored in the requirements and test plan database and is used to provide data for requirements for pre-existing test(s) and/or such pre-existing test(s) in blocks of FIG. 2A.

Returning to FIG. 2A, in optional block 220-3, whether any requirements of each of one or more pre-existing test plans have a similarity with the requirements for the new test plan which exceeds a first similarity threshold level is determined. Such first similarity threshold level and/or a second similarity threshold level may be provided by a user and/or a system which provides the requirements for the new test plan, provided a designer of a system implementing an embodiment of the invention, and/or provided by an embodiment of the invention during operation of the embodiment.

A similar test plan is a pre-existing test plan whose requirements' similarity with the requirements for the new test plan exceeds the first similarity threshold level. Similar requirements are requirements of a pre-existing test plan whose similarity with the requirements for the new test plan exceeds the first similarity threshold level.

If no requirements of each of the one or more pre-exiting test plans have a similarity with the requirements for the new test plan that exceed the first similarity threshold level, then proceed to block 220-1. Optionally, a user and/or a system requesting the requirements for the new test plan is notified that a similar requirement for a pre-existing test plan was not identified and/or is requested to modify the previously received requirements for the new test plan. If any requirements of one or more pre-exiting test plans have a similarity with the requirements for the new test plan exceeds the first similarity threshold level, then in optional block 220-4, each similar test plan and corresponding similar requirements thereof, and the requirements for the new test plan are provided to the generative AI.

In block 220-5, using each similar test plan and corresponding similar requirements thereof, and the requirements for the new test plan, a new test plan is generated with the generative AI. Optionally, in block 220-5, the neural network, e.g., the generative AI, provides the new test plan to the state machine. Optionally, if optional blocks 220-2, 220-3, and 220-4 are not used, then proceed from block 220-1 to block 220-5; in such case block 220-5 just entails generating, with generative AI, the new test plan.

In optional block 220-6, a similarity between the new test plan and each similar test plan is determined. In optional block 220-7, using the similarity between the new test plan and each similar test plan, the similarity between each of the corresponding similar requirements and the requirements for the new test is received by and/or modified in, e.g., the state machine 102, e.g., the requirements and test plan database 102-3.

In optional block 220-8, whether at least one determined similarity between the new test plan and a similar test plan exceeds the second similarity threshold level is determined. If at least one determined similarity between the new test plan and a similar test plan exceeds the second similarity threshold level is not determined, then optionally proceed to block 220-5.

If at least one determined similarity exceeds the second similarity threshold level, then in block 220-9 the new test is provided to the user and/or the system. Optionally, prior to providing the new test to the user and/or the system, the new test is converted, e.g., with one of the decoder(s), from a vectorized format (in vector space) to a human and/or machine readable format. Optionally, block 220-9 includes providing or updating a similarity score for the requirements of the new test plan with respect to the requirements of at least one pre-existing test plan and/or at least one requirement of a pre-existing test plan Optionally, in block 220-10, each determined similarity which exceeds the second similarity threshold level is received by and/or modified in, e.g., the state machine 102, e.g., the requirements and test plan database 102-3.

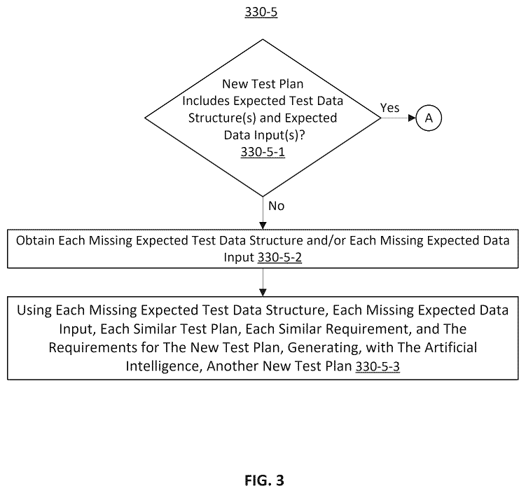

FIG. 3 illustrates a flow diagram of one embodiment of a method 330-5 of generating, with generative AI, a new test plan. However, block 220-5 may be implemented in other ways.

Exemplary method 330-5 may be implemented by the apparatuses illustrated in FIG. 1. Techniques described with respect to the embodiments illustrated by FIG. 1 may be applicable to the method 330-5. Optionally, each block of method 330-5 is performed by the state machine or the neural network, e.g., the generative AI.

In block 330-5-1, whether the new test plan includes expected data structure(s) and expected data input(s) is determined. If the new test plan is determined to include the expected data structure(s) and the expected data input(s), then optionally proceed to optional block 220-6.

If the new test plan is determined not to include the expected data structure(s) and the expected data input(s), then, in block 330-5-2, obtain, e.g., from the test plan design guidelines 104-1-1, each missing expected test data structure and each missing expected data input. Using each missing expected test data structure, each missing expected data input, each similar test plan, each similar requirement, and the requirements for the new test plan, then, in block 330-5-3, another new test plan is generated by the AI. After block 330-5-3, then proceed to optional block 220-6.

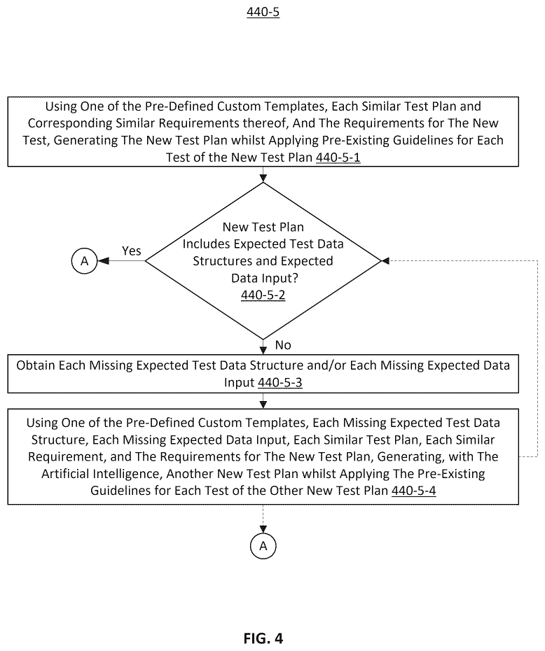

FIG. 4 illustrates a flow diagram of one embodiment of a method 440-5 of generating, with generative AI, a new test plan. Exemplary method 440-5 may be implemented by the apparatuses illustrated in FIG. 1. However, block 220-5 may be implemented in other ways.

Techniques described with respect to the embodiments illustrated by FIG. 1 may be applicable to the method 440-5. Optionally, blocks 440-5-1 and 440-5-4 are performed by the neural network, e.g., the generative AI. Optionally, the blocks of method 440-5 are each performed by the state machine or the neural network.

In block 440-5-1, using one of the pre-defined custom templates, each similar test plan and corresponding similar requirements thereof, and the requirements for the new test, the new test plan is generated, using the generative AI, whilst applying test plan guidelines for each test of the new test plan. In block 440-5-2, whether the new test plan includes the expected test data structure(s) and the expected data input(s) is determined. If the new test plan does include the expected test data structure(s) and the expected data input(s), then proceed to optional block 220-6. If the new test plan does not include the expected test data structure(s) and the expected data input(s), then, in block 440-5-3, obtain, e.g., from the test plan design guidelines 104-1-1, each missing expected test data structure and each missing expected data input. Using one of the pre-defined custom templates, each missing expected test data structure, each missing expected data input, each similar test plan, each similar requirement, and the requirements for the new test plan, then, in block 440-5-4, another new test plan is generated by the AI whilst applying the pre-exiting guidelines for each test of the other new test plan. Optionally, in block 440-5-4, the other new test plan is provided by the neural network, e.g., the generative AI, to the state machine. After block 330-5-3, then proceed to optional block 220-6 or block 440-5-2.

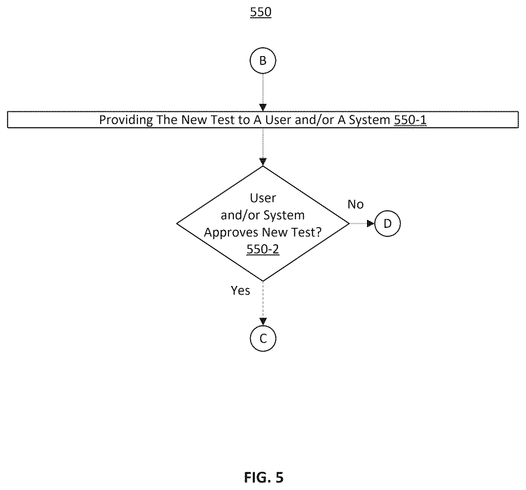

FIG. 5 illustrates a flow diagram of one embodiment of a method 550 of obtaining user and/or system approval of a new test plan when at least one determined similarity between the new test plan and a similar test plan does not exceed the second similarity threshold level. Method 550 is performed in lieu of returning to block 220-5 in FIG. 2A when at least one determined similarity between the new test plan and a similar test plan does not exceed the second similarity threshold level. Optionally, each block of method 550 is performed by the state machine or the neural network, e.g., the generative AI.

In optional block 220-8, if at least one determined similarity between the new test plan and a similar test plan exceeds the second similarity threshold level is not determined, then optionally proceed to block 550-1. In block 550-1, the new test plan is provided to the user and/or the system. In block 550-2, whether the user and/or the system approves the new test plan is determined. If the user and/or the system approves the new test plan, then optionally proceed to optional block 220-10. If the user and/or the system does not approve the new test plan, then optionally proceed to block 220-1.

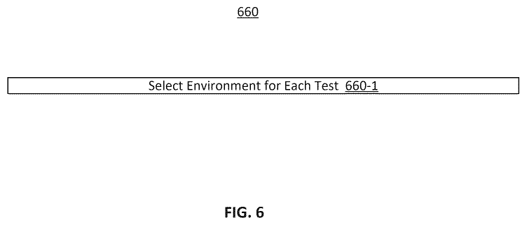

FIG. 6 illustrates a flow diagram of one embodiment of a method 660 of generating a new test plan. In block 660-1, an environment for each test of the new test plan is selected, e.g., based on a type of test of each test, optionally using the environment selector 104-1-3 and/or environment types 104-1-4. Optionally, block 660-1 is performed by the state machine or the neural network, e.g., the generative AI.

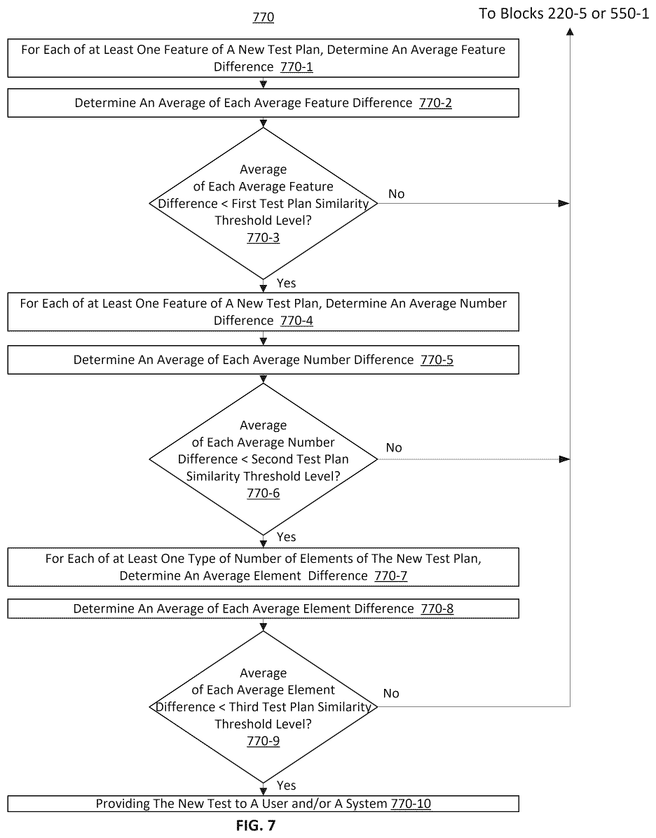

FIG. 7 illustrates a flow diagram of one embodiment of a method 770 of determining whether at least one determined similarity between the new test plan and a similar test plan exceeds the second similarity threshold level is determined. However, block 220-8 may be implemented in other ways. Optionally, each block of method 770 is performed by the state machine or the neural network, e.g., the generative AI.

In block 770-1, for each of at least one feature of the new test plan, an average difference, between a feature of the new test plan and a corresponding feature of old test plan(s) utilized by the generative AI to create the new test plan, (or average feature difference) is determined. Each feature is a characteristic, e.g., a parameter value range or a parameter value type, of the test plan, e.g., timing and/or frequency of input and/or output signals.

In block 770-2, an average of each average feature difference is determined. In block 770-3, whether the average of each average feature difference is less than a first test plan similarity threshold level is determined.

If the average of each average feature difference is less than the first test plan similarity threshold level, then in block 770-4, for each of at least one type of number of elements in the new test plan, an average difference, between a number of elements of one type in the new test plan and a corresponding number of elements of the one type in the old test plan(s) utilized by the generative AI to create the new test plan, (or average number difference) is determined. Each type of a number of elements may be data generated using the old and new test plans, a number of test cases in the old and the new test plans, a number of input signal(s) and/or signal parameter(s) specified in the old and new test plans, a number of output signal(s) and/or signal parameter(s) specified in the old and new test plans, and/or any other number of characteristic(s) of the old and new test plans.

In block 770-5, an average of each average number difference is determined. In block 770-6, whether the average of each average number difference is less than a second test plan similarity threshold level is determined. If the average of each average number difference is less than the second test plan similarity threshold level, then, in block 770-7, for each of at least one parameter data element in the new test plan, an average difference, between a data element in the new test plan and a corresponding data element in the old test plan(s) utilized by the generative AI to create the new test plan, (or average element difference) is determined. Each data element may be a data type or range of an input parameter, an output parameter, or any other parameter used in the new and old test plans.

In block 770-8, an average of each average element difference is determined. In block 770-9, whether the average of each average element difference is less than a third test plan similarity threshold level is determined. If the average of each average element difference is less than the third test plan similarity threshold level, then, in block 770-10 the new test plan is provided to a user and/or a system. If either the average of each average feature difference is not less than the first test plan similarity threshold level, the average of each average number difference is not less than the second test plan similarity threshold level, or the average of each average element difference is less than the third test plan similarity threshold level, then proceed to block 220-5 or to block 550-1.

While the present teachings have been illustrated with respect to one or more implementations, alterations and/or modifications can be made to the illustrated examples without departing from the scope of the appended claims. In addition, while a particular feature of the present disclosure may have been described with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and/or the claims, such terms are intended to be inclusive in a manner similar to the term “comprising.” The term “at least one of” is used to mean one or more of the listed items can be selected. As used herein, the term “one or more of” with respect to a listing of items such as, for example, A and B or A and/or B, means A alone, B alone, or A and B. The term “at least one of” is used to mean one or more of the listed items can be selected.

A processing system may include processor circuitry coupled to memory circuitry. The processor circuitry described herein may include one or more microprocessors, microcontrollers, digital signal processing (DSP) elements, application-specific integrated circuits (ASICs), and/or field programmable gate arrays (FPGAs). In this exemplary embodiment, processor circuitry includes or functions with software programs, firmware, or other computer readable instructions for carrying out various process tasks, calculations, and control functions, used in the methods described herein. These instructions are typically tangibly embodied on any storage media (or computer readable medium) used for storage of computer readable instructions or data structures.

The memory circuitry described herein can be implemented with any available storage media (or computer readable medium) that can be accessed by a general purpose or special purpose computer or processor, or any programmable logic device. Suitable computer readable medium may include storage or memory media such as semiconductor, magnetic, and/or optical media. For example, computer readable media may include conventional hard disks, Compact Disk-Read Only Memory (CD-ROM), DVDs, volatile or non-volatile media such as Random Access Memory (RAM) (including, but not limited to, Dynamic Random Access Memory (DRAM)), Read Only Memory (ROM), Electrically Erasable Programmable ROM (EEPROM), and/or flash memory. Combinations of the above are also included within the scope of computer readable media.

Methods of the invention can be implemented in computer readable instructions, such as program modules or applications, which may be stored in the computer readable medium that is part of (optionally the memory circuitry) or communicatively coupled to the processing circuitry, and executed by the processing circuitry, optionally the processor circuitry. Generally, program modules or applications include routines, programs, objects, data components, data structures, algorithms, and the like, which perform particular tasks or implement particular abstract data types.

### EXAMPLE EMBODIMENTS

Example 1 includes a method for automatically generating a new test plan, the method comprising: receiving requirements for the new test plan; determining a similarity between requirements for each of one or more pre-existing test plans and the requirements for the new test plan; determining whether any requirements of each of one or more pre-existing test plans have a similarity with the requirements for the new test plan which exceeds a first similarity threshold level; determining that requirements of one or more pre-exiting test plans have a similarity with the requirements for the new test plan exceeds the first similarity threshold level, then providing to artificial intelligence (AI), each similar test plan and corresponding similar requirements thereof, and the requirements for the new test plan, wherein a similar test plan is a pre-existing test plan whose requirements' similarity with the requirements for the new test plan exceeds the first similarity threshold level, and wherein similar requirements are requirements, of a pre-existing test plan, whose similarity with the requirements for the new test plan exceeds the first similarity threshold level; using each similar test plan and corresponding similar requirements thereof, and the requirements for the new test plan, generating, with the AI, a new test plan; determining a similarity between the new test plan and each similar test plan; using the determined similarity between the new test plan and each similar test plan, providing and/or modifying the similarity between each of the corresponding similar requirements and the requirements for the new test plan; determining whether at least one determined similarity between the new test plan and a similar test plan exceeds a second similarity threshold level; and determine that the at least one determined similarity exceeds the second similarity threshold level, then providing the new test plan to a user and/or a system.

Example 2 includes the method of Example 1, wherein the AI includes generative AI.

Example 3 includes the method of any of Examples 1-2, further comprising after providing the new test plan, then receiving and/or modifying each determined similarity which exceeds the second similarity threshold level.

Example 4 includes the method of any of Examples 1-3, wherein generating the new test plan further comprises: determining whether the new test plan includes expected at least one data structure and expected at least one data input; determine that the new test plan does not include each expected data structure and each expected data input, then obtaining each missing expected test data structure and each missing expected data input; and using each missing expected test data structure, each missing expected data input, each similar test plan, each similar requirement, and the requirements for the new test plan, generating, with the AI, another new test plan.

Example 5 includes the method of any of Examples 1-4, wherein generating the new test plan comprises: using one of pre-defined custom templates, each similar test plan and the corresponding similar requirements thereof, and the requirements for the new test plan, generating the new test plan whilst applying test plan guidelines for each test of the new test plan; determining whether the new test plan includes expected at least one data structure and expected at least one data input; determine that the new test plan does not include each expected data structure and each expected data input, then obtaining each missing expected test data structure and each missing expected data input; and using one of the pre-defined custom templates, each missing expected test data structure, each missing expected data input, each similar test plan and the corresponding requirements thereof, and the requirements for the new test plan, then generating, with the AI, another new test plan whilst applying the test plan guidelines for each test of the other new test plan.

Example 6 includes the method of Example 5, further comprising receiving, at the AI, the test plan guidelines or modifications thereof and/or the pre-defined custom templates or modifications thereof.

Example 7 includes the method of any of Examples 1-6, wherein providing the new test plan to the user and/or the system further comprises providing or updating a similarity score for the requirements of the new test plan with respect to the requirements of at least one pre-existing test plan and/or at least one requirement of a pre-existing test plan.

Example 8 includes the method of any of Examples 1-7, wherein generating the new test plan comprises selecting an environment for each test of the new test plan based on a type of test of each test.

Example 9 includes the method of any of Examples 1-8, wherein determining the similarity between the requirements for each of the one or more pre-existing test plans and the requirements for the new test plan comprises: identifying classes of features, in vector space, in an aggregate of requirements for the one or more pre-existing test; determining a centroid of each class; generating a class database including each class, a vector value for each element of each class, and the centroid of each class; for at least one class, determining a subset of unique vector elements in the vector space that are within a first vector threshold distance of a centroid of a class; for at least one class, determining a centroid of the subset of unique vector elements associated with a class; and for at least one class, determining elements of a class, in the class database, within a second vector threshold distance of the centroid of the class.

Example 10 includes an apparatus for automatically generating a new test plan, the apparatus comprising: state machine circuitry configured to: receive requirements for the new test plan; determine a similarity between requirements for each of one or more pre-existing test plans and the requirements for the new test plan; and determine whether any requirements of each of one or more pre-existing test plans have a similarity with the requirements for the new test plan which exceeds a first similarity threshold level; and neural network circuitry configured to execute artificial intelligence (AI), and further configured to: determining that requirements of one or more pre-exiting test plans have a similarity with the requirements for the new test plan exceeds the first similarity threshold level, then receiving at the AI, each similar test plan and corresponding similar requirements thereof, and the requirements for the new test plan, wherein a similar test plan is a pre-existing test plan whose requirements' similarity with the requirements for the new test plan exceeds the first similarity threshold level, and wherein similar requirements are requirements, of a pre-existing test plan, whose similarity with the requirements for the new test plan exceeds the first similarity threshold level; and using each similar test plan and corresponding similar requirements thereof, and the requirements for the new test plan, generating, with the AI, a new test plan; wherein the state machine circuitry is further configured to: determine a similarity between the new test plan and each similar test plan; using the determined similarity between the new test plan and each similar test plan, provide and/or modify the similarity between each of the corresponding similar requirements and the requirements for the new test plan; determine whether at least one determined similarity between the new test plan and a similar test plan exceeds a second similarity threshold level; and determine that the at least one determined similarity exceeds the second similarity threshold level, then provide the new test plan to a user and/or a system.

Example 11 includes the apparatus of Example 10, wherein the AI includes generative AI.

Example 12 includes the apparatus of any of Examples 10-11, wherein the state machine circuitry is further configured to, after providing the new test plan, to then receive and/or modify, in the state machine circuitry, each determined similarity which exceeds the second similarity threshold level.

Example 13 includes the apparatus of any of Examples 10-12, wherein generate the new test plan further comprises: determine whether the new test plan includes expected at least one data structure and expected at least one data input; determine that the new test plan does not include each expected data structure and each expected data input, then obtain each missing expected test data structure and each missing expected data input; and using each missing expected test data structure, each missing expected data input, each similar test plan, each similar requirement, and the requirements for the new test plan, generate, with the AI, another new test plan.

Example 14 includes the apparatus of any of Examples 10-13, wherein generate the new test plan comprises: using one of pre-defined custom templates, each similar test plan and the corresponding similar requirements thereof, and the requirements for the new test plan, generate the new test plan whilst applying test plan guidelines for each test of the new test plan; determine whether the new test plan includes expected at least one data structure and expected at least one data input; determine that the new test plan does not include each expected data structure and each expected data input, then obtain each missing expected test data structure and each missing expected data input; and using one of the pre-defined custom templates, each missing expected test data structure, each missing expected data input, each similar test plan and the corresponding requirements thereof, and the requirements for the new test plan, then generate, with the AI, another new test plan whilst applying the test plan guidelines for each test of the other new test plan.

Example 15 includes the apparatus of Example 14, wherein the neural network circuitry is further configured to receive, at the AI, the test plan guidelines or modifications thereof and/or the pre-defined custom templates or modifications thereof.

Example 16 includes the apparatus of any of Examples 10-15, wherein providing the new test plan to the user and/or the system further comprises providing or updating a similarity score for the requirements of the new test plan with respect to the requirements of at least one pre-existing test plan and/or at least one requirement of a pre-existing test plan.

Example 17 includes the apparatus of any of Examples 10-16, wherein generate the new test plan comprises selecting an environment for each test of the new test plan based on a type of test of each test.

Example 18 includes the apparatus of any of Examples 10-17, wherein determine the similarity between the requirements for each of the one or more pre-existing test plans and the requirements for the new test plan comprises: identify classes of features, in vector space, in an aggregate of requirements for the one or more pre-existing test; determine a centroid of each class; generate a class database including each class, a vector value for each element of each class, and a centroid of each class; for at least one class, determine a subset of unique vector elements in the vector space that are within a first vector threshold distance of a centroid of a class; for at least one class, determining a centroid of the subset of unique vector elements associated with a class; and for at least one class, determine elements of a class, in the class database, within a second vector threshold distance of the centroid of the class.

Example 19 includes a method for automatically generating a new test plan, the method comprising: receiving requirements for the new test plan; using one of pre-defined custom templates, the requirements for the new test plan, generate, with artificial intelligence (AI), the new test plan whilst applying test plan guidelines for each test of the new test plan; wherein generating the new test plan includes selecting an environment for each test of the new test plan based on a type of test of each test; and providing the new test plan to a user and/or a system.

Example 20 includes the method of Example 19, further comprising: determining whether the new test plan includes expected at least one data structure and expected at least one data input; determining that the new test plan does not include each expected data structure and each expected data input, then obtaining each missing expected test data structure and each missing expected data input; and using one of the pre-defined custom templates, each missing expected test data structure, each missing expected data input, and the requirements for the new test plan, then generating, with the AI, another new test plan whilst applying the test plan guidelines for each test of the other new test plan.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A method for automatically generating a new test plan, the method comprising:
receiving requirements for the new test plan;
determining a similarity between requirements for each of one or more pre-existing test plans and the requirements for the new test plan;
determining whether any requirements of each of one or more pre-existing test plans have a similarity with the requirements for the new test plan which exceeds a first similarity threshold level;
determining that requirements of one or more pre-exiting test plans have a similarity with the requirements for the new test plan exceeds the first similarity threshold level, then providing to artificial intelligence (AI), each similar test plan and corresponding similar requirements thereof, and the requirements for the new test plan, wherein a similar test plan is a pre-existing test plan whose requirements' similarity with the requirements for the new test plan exceeds the first similarity threshold level, and wherein similar requirements are requirements, of a pre-existing test plan, whose similarity with the requirements for the new test plan exceeds the first similarity threshold level;
using each similar test plan and corresponding similar requirements thereof, and the requirements for the new test plan, generating, with the AI, a new test plan;
determining a similarity between the new test plan and each similar test plan;
using the determined similarity between the new test plan and each similar test plan, providing and/or modifying the similarity between each of the corresponding similar requirements and the requirements for the new test plan;
determining whether at least one determined similarity between the new test plan and a similar test plan exceeds a second similarity threshold level; and
determine that the at least one determined similarity exceeds the second similarity threshold level, then providing the new test plan to a user and/or a system.

2. The method of claim 1, wherein the AI includes generative AI.

3. The method of claim 1, further comprising after providing the new test plan, then receiving and/or modifying each determined similarity which exceeds the second similarity threshold level.

4. The method of claim 1, wherein generating the new test plan further comprises:
determining whether the new test plan includes expected at least one data structure and expected at least one data input;
determine that the new test plan does not include each expected data structure and each expected data input, then obtaining each missing expected test data structure and each missing expected data input; and
using each missing expected test data structure, each missing expected data input, each similar test plan, each similar requirement, and the requirements for the new test plan, generating, with the AI, another new test plan.

5. The method of claim 1, wherein generating the new test plan comprises:
using one of pre-defined custom templates, each similar test plan and the corresponding similar requirements thereof, and the requirements for the new test plan, generating the new test plan whilst applying test plan guidelines for each test of the new test plan;
determining whether the new test plan includes expected at least one data structure and expected at least one data input;
determine that the new test plan does not include each expected data structure and each expected data input, then obtaining each missing expected test data structure and each missing expected data input; and
using one of the pre-defined custom templates, each missing expected test data structure, each missing expected data input, each similar test plan and the corresponding requirements thereof, and the requirements for the new test plan, then generating, with the AI, another new test plan whilst applying the test plan guidelines for each test of the other new test plan.

6. The method of claim 5, further comprising receiving, at the AI, the test plan guidelines or modifications thereof and/or the pre-defined custom templates or modifications thereof.

7. The method of claim 1, wherein providing the new test plan to the user and/or the system further comprises providing or updating a similarity score for the requirements of the new test plan with respect to the requirements of at least one pre-existing test plan and/or at least one requirement of a pre-existing test plan.

8. The method of claim 1, wherein generating the new test plan comprises selecting an environment for each test of the new test plan based on a type of test of each test.

9. The method of claim 1, wherein determining the similarity between the requirements for each of the one or more pre-existing test plans and the requirements for the new test plan comprises:
identifying classes of features, in vector space, in an aggregate of requirements for the one or more pre-existing test;
determining a centroid of each class;
generating a class database including each class, a vector value for each element of each class, and the centroid of each class;
for at least one class, determining a subset of unique vector elements in the vector space that are within a first vector threshold distance of a centroid of a class;
for at least one class, determining a centroid of the subset of unique vector elements associated with a class; and
for at least one class, determining elements of a class, in the class database, within a second vector threshold distance of the centroid of the class.

10. An apparatus for automatically generating a new test plan, the apparatus comprising:
state machine circuitry configured to:
receive requirements for the new test plan;
determine a similarity between requirements for each of one or more pre-existing test plans and the requirements for the new test plan; and
determine whether any requirements of each of one or more pre-existing test plans have a similarity with the requirements for the new test plan which exceeds a first similarity threshold level; and
neural network circuitry configured to execute artificial intelligence (AI), and further configured to:
determining that requirements of one or more pre-exiting test plans have a similarity with the requirements for the new test plan exceeds the first similarity threshold level, then receiving at the AI, each similar test plan and corresponding similar requirements thereof, and the requirements for the new test plan, wherein a similar test plan is a pre-existing test plan whose requirements' similarity with the requirements for the new test plan exceeds the first similarity threshold level, and wherein similar requirements are requirements, of a pre-existing test plan, whose similarity with the requirements for the new test plan exceeds the first similarity threshold level; and
using each similar test plan and corresponding similar requirements thereof, and the requirements for the new test plan, generating, with the AI, a new test plan;
wherein the state machine circuitry is further configured to:
determine a similarity between the new test plan and each similar test plan;
using the determined similarity between the new test plan and each similar test plan, provide and/or modify the similarity between each of the corresponding similar requirements and the requirements for the new test plan;
determine whether at least one determined similarity between the new test plan and a similar test plan exceeds a second similarity threshold level; and
determine that the at least one determined similarity exceeds the second similarity threshold level, then provide the new test plan to a user and/or a system.

11. The apparatus of claim 10, wherein the AI includes generative AI.

12. The apparatus of claim 10, wherein the state machine circuitry is further configured to, after providing the new test plan, to then receive and/or modify, in the state machine circuitry, each determined similarity which exceeds the second similarity threshold level.

13. The apparatus of claim 10, wherein generate the new test plan further comprises:
determine whether the new test plan includes expected at least one data structure and expected at least one data input;
determine that the new test plan does not include each expected data structure and each expected data input, then obtain each missing expected test data structure and each missing expected data input; and
using each missing expected test data structure, each missing expected data input, each similar test plan, each similar requirement, and the requirements for the new test plan, generate, with the AI, another new test plan.

14. The apparatus of claim 10, wherein generate the new test plan comprises:
using one of pre-defined custom templates, each similar test plan and the corresponding similar requirements thereof, and the requirements for the new test plan, generate the new test plan whilst applying test plan guidelines for each test of the new test plan;
determine whether the new test plan includes expected at least one data structure and expected at least one data input;
determine that the new test plan does not include each expected data structure and each expected data input, then obtain each missing expected test data structure and each missing expected data input; and
using one of the pre-defined custom templates, each missing expected test data structure, each missing expected data input, each similar test plan and the corresponding requirements thereof, and the requirements for the new test plan, then generate, with the AI, another new test plan whilst applying the test plan guidelines for each test of the other new test plan.

15. The apparatus of claim 14, wherein the neural network circuitry is further configured to receive, at the AI, the test plan guidelines or modifications thereof and/or the pre-defined custom templates or modifications thereof.

16. The apparatus of claim 10, wherein providing the new test plan to the user and/or the system further comprises providing or updating a similarity score for the requirements of the new test plan with respect to the requirements of at least one pre-existing test plan and/or at least one requirement of a pre-existing test plan.

17. The apparatus of claim 10, wherein generate the new test plan comprises selecting an environment for each test of the new test plan based on a type of test of each test.

18. The apparatus of claim 10, wherein determine the similarity between the requirements for each of the one or more pre-existing test plans and the requirements for the new test plan comprises:
identify classes of features, in vector space, in an aggregate of requirements for the one or more pre-existing test;
determine a centroid of each class;
generate a class database including each class, a vector value for each element of each class, and a centroid of each class;
for at least one class, determine a subset of unique vector elements in the vector space that are within a first vector threshold distance of a centroid of a class;
for at least one class, determining a centroid of the subset of unique vector elements associated with a class; and
for at least one class, determine elements of a class, in the class database, within a second vector threshold distance of the centroid of the class.

19. A method for automatically generating a new test plan, the method comprising:
receiving requirements for the new test plan;
using one of pre-defined custom templates, the requirements for the new test plan, generate, with artificial intelligence (AI), the new test plan whilst applying test plan guidelines for each test of the new test plan;
wherein generating the new test plan includes selecting an environment for each test of the new test plan based on a type of test of each test; and
providing the new test plan to a user and/or a system.

20. The method of claim 19, further comprising:
determining whether the new test plan includes expected at least one data structure and expected at least one data input;
determining that the new test plan does not include each expected data structure and each expected data input, then obtaining each missing expected test data structure and each missing expected data input; and
using one of the pre-defined custom templates, each missing expected test data structure, each missing expected data input, and the requirements for the new test plan, then generating, with the AI, another new test plan whilst applying the test plan guidelines for each test of the other new test plan.
